(19) United States
(12) Patent Application Publication
(10) Pub. No.: US 2013/0033749 A1
(43) Pub. Date: Feb. 7, 2013

(54) STEREO DISPLAY DEVICE AND SWITCHING PANEL USED IN STEREO DISPLAY DEVICE

(71) Applicants: Mien-Mien Cheng, Kaohsiung City (TW); Chun-Hsien Yeh, Taipei City (TW)

(72) Inventors: Mien-Mien Cheng, Kaohsiung City (TW); Chun-Hsien Yeh, Taipei City (TW)

(73) Assignee: AU OPTRONICS CORPORATION, Hsinchu (TW)

(21) Appl. No.: 13/291,049

(22) Filed: Nov. 7, 2011

(30) Foreign Application Priority Data
Aug. 2, 2011 (TW) 100127433

(51) Int. Cl. G02B 27/22

(52) U.S. Cl. 359/464

(57) ABSTRACT

A stereo display device includes a display panel and a switching panel. The display panel has a plurality of unit regions, and each of the unit regions includes a right eye unit region and a left eye unit region. The switching panel is disposed on the display panel and includes a first substrate, a second substrate, a plurality of electrode patterns and an optically anisotropic medium. The first substrate and the second substrate are disposed opposite to each other. The electrode patterns are disposed on the second substrate. The optically anisotropic medium is disposed between the first substrate and the second substrate.

### CROSS-REFERENCE TO RELATED APPLICATION

This application claims the priority benefit of Taiwan application serial no. 100127433, filed on Aug. 2, 2011. The entirety of the above-mentioned patent application is hereby incorporated by reference herein and made a part of this specification.

### BACKGROUND OF THE INVENTION

1. Field of the Invention

The invention relates to a stereo display device and a switching panel that is used in a stereo display device.

2. Description of Related Art

At present, stereo display technologies can be approximately categorized into auto-stereoscopic technologies that allow a viewer to directly watch images with naked eyes and stereoscopic technologies that require the viewer to wear specially designed glasses. According to the operational principle of an auto-stereoscopic stereo display device, a fixed barrier is utilized to control images received by left and right eyes of the viewer. Owing to visual characteristics of human eyes, when images with different parallax are respectively captured by the viewer's left and right eyes, the images that seem to be superposed may be perceived as a stereo image. By contrast, according to the operational principle of a stereoscopic stereo display device, the display device displays left-eye and right-eye frames. Through wearing glasses, the left and right eyes of the viewer may receive different images, which are combined to form a stereo image.

In general, cylindrical lenses are required to be disposed on the display panel of the auto-stereoscopic stereo display device, such that the right-eye and left-eye frames displayed on the display panel can be respectively sent to the right and left eyes of the viewer. Besides, in order for the stereo display device to switch between the two-dimensional display mode and the three-dimensional display mode, a liquid crystal switching panel is frequently disposed above the display panel. Nonetheless, the stereo display device constituted by the display panel, the liquid crystal switching panel, and the cylindrical lenses cannot have the reduced thickness. Moreover, fabrication of said stereo display device is complicated, and the manufacturing costs are relatively high.

### SUMMARY OF THE INVENTION

The invention is directed to a stereo display device with the reduced thickness and a switching panel used in a stereo display device for reducing the entire thickness of the stereo display device.

In an embodiment of the invention, a stereo display device that includes a display panel and a switching panel is provided. The display panel has a plurality of unit regions, and each of the unit regions includes a right-eye unit region and a left-eye unit region. The switching panel is located above the display panel and includes a first substrate, a second substrate, a plurality of electrode patterns, and an optically anisotropic medium. The second substrate is located opposite to the first substrate. The electrode patterns are located on the second substrate. The optically anisotropic medium is located between the first substrate and the second substrate.

In an embodiment of the invention, a switching panel of a stereo display device is further provided. The switching panel is suitable for being combined with a display panel to form the stereo display device. The display panel has a plurality of unit regions, and each of the unit regions includes a left-eye unit region and a right-eye unit region. The switching panel of the stereo display device includes a first substrate, a second substrate, a plurality of electrode patterns, and an optically anisotropic medium. The second substrate is located opposite to the first substrate. The electrode patterns are located on the second substrate. Two adjacent electrode patterns of the electrode patterns are disposed corresponding to one of the unit regions of the display panel. The optically anisotropic medium is located between the first substrate and the second substrate.

Based on the above, the stereo display device described in the embodiments of the invention can achieve the stereo display effect merely by disposing the switching panel above the display panel, and the switching panel allows the stereo display device to switch between the two-dimensional display mode and the three-dimensional display mode. Since the cylindrical lenses need not be disposed on the display panel of the stereo display device according to the embodiments of the invention, the entire thickness of the stereo display device is less than the thickness of the conventional stereo display device. Moreover, fabrication of the stereo display device of this invention is less complicated and more cost-effective.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A and FIG. 1B are schematic cross-sectional views respectively illustrating a stereo display device according to an embodiment of the invention.

FIG. 1C is a schematic simulation diagram illustrating the arrangement of an optically anisotropic medium between two electrode patterns in the stereo display device depicted in FIG. 1B.

FIG. 2 is a schematic cross-sectional view illustrating a display panel in the stereo display device depicted in FIG. 1A and FIG. 1B.

FIG. 3 is a schematic view illustrating a unit region in the display panel of the stereo display device depicted in FIG. 1A and FIG. 1B.

FIG. 4A is a schematic top view illustrating a second substrate of a switching panel in the stereo display device depicted in FIG. 1A and FIG. 1B.

FIG. 4B is a schematic top view illustrating a display panel in the stereo display device depicted in FIG. 1A and FIG. 1B.

FIG. 5A is a schematic top view illustrating a second substrate of a switching panel in a stereo display device according to another embodiment of the invention.

FIG. 5B is a schematic top view illustrating a display panel of the stereo display device according to another embodiment of the invention.

FIG. 6 to FIG. 12 are schematic cross-sectional views illustrating a switching panel in a stereo display device according to several embodiments of the invention.

### DESCRIPTION OF EMBODIMENTS

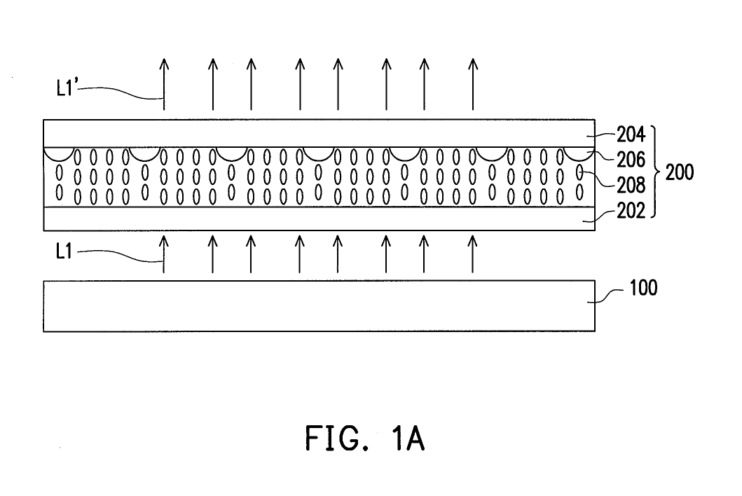

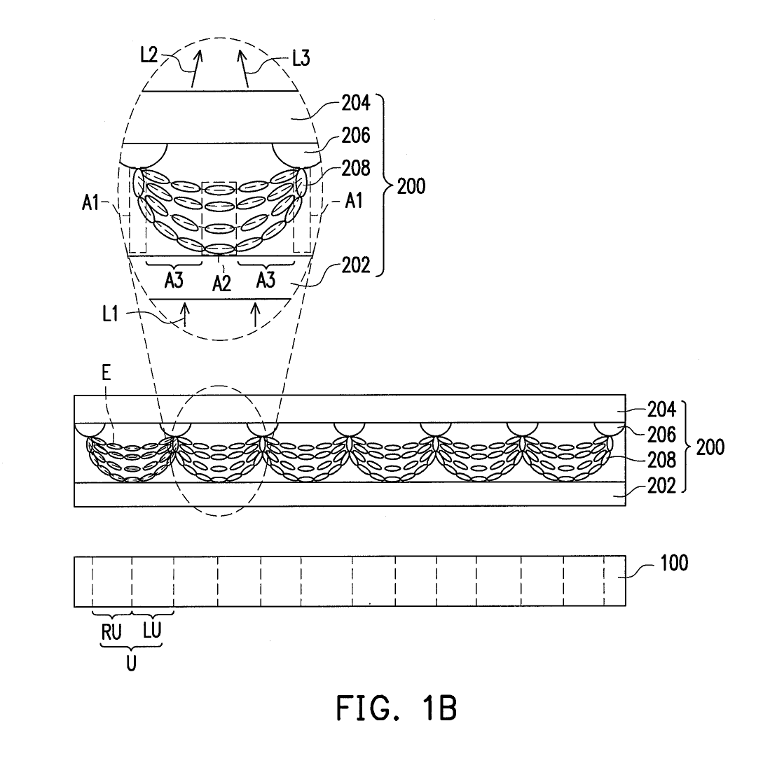

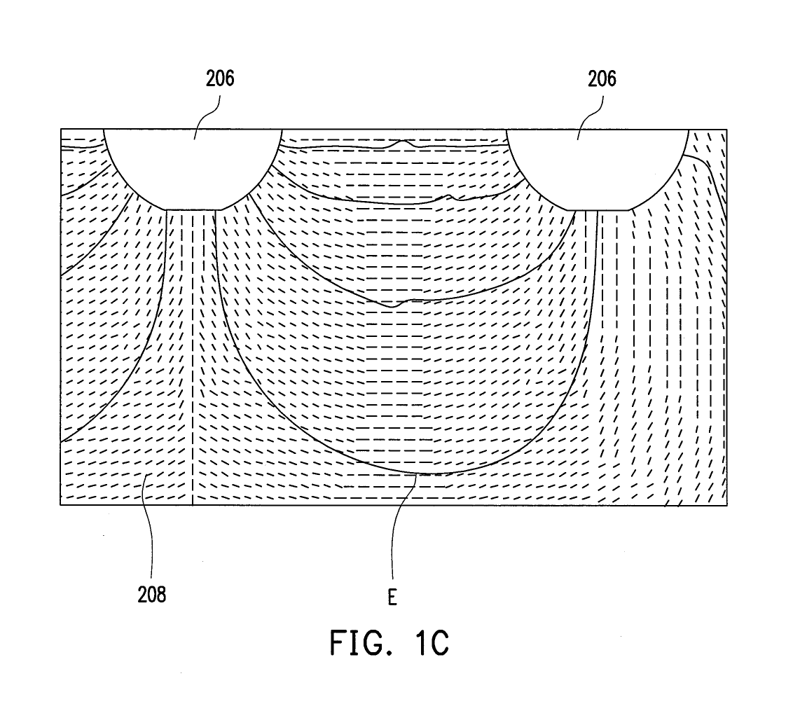

FIG. 1A and FIG. 1B are schematic cross-sectional views respectively illustrating a stereo display device according to an embodiment of the invention. Specifically, FIG. 1A schematically shows that no voltage is applied to a switching panel of the stereo display device, while FIG. 1B schematically shows that a voltage is applied to the switching panel of the stereo display device. With reference to FIG. 1A and FIG. 1B, the stereo display device of this embodiment includes a display panel 100 and a switching panel 200.

The display panel 100 has a plurality of unit regions U, and each of the unit regions U includes a right-eye unit region RU and a left-eye unit region LU. According to this embodiment, in the display panel 100 shown in FIG. 2, the left-eye unit region LU of each of the unit regions U includes at least one pixel structure P, and the right-eye unit region RU of each of the unit regions U includes at least one pixel structure P′. The pixel structure P of this embodiment includes three sub-pixel structures SP1, SP2, and SP3. For instance, the sub-pixel structure SP1 is a red sub-pixel structure (R), the sub-pixel structure SP2 is a green sub-pixel structure (G), and the sub-pixel structure SP3 is a blue sub-pixel structure (B). Similarly, the pixel structure P′ of this embodiment includes three sub-pixel structures SP1′, SP2′, and SP3′. For instance, the sub-pixel structure SP1′ is a red sub-pixel structure (R′), the sub-pixel structure SP2′ is a green sub-pixel structure (G′), and the sub-pixel structure SP3′ is a blue sub-pixel structure (B′). Each of the sub-pixel structures (SP1, SP2, SP3, SP1′, SP2′, and SP3′) is electrically connected to a corresponding data line and a corresponding scan line and includes at least one active device and at least one pixel electrode.

However, the number of the pixel structure P in the left-eye unit region LU and the number of the pixel structure P′ in the right-eye unit region RU are not limited in the invention. That is to say, according to other embodiments of the invention, the left-eye unit region LU can include two or more pixel structures P, and the right-eye unit region RU can include two or more pixel structures P′. Although each of the pixel structures P and P′ exemplarily includes three sub-pixel structures in this embodiment, the number of the sub-pixel structures in each of the pixel structures P and P′ is not limited in the invention. Namely, in other embodiments of the invention, each of the pixel structures P and P′ can include one, two, four, or more sub-pixel structures.

The display panel 100 can be any display panel that can display images. For instance, the display panel 100 can be a liquid crystal display (LCD) panel, an organic electroluminescent display (OELD) panel, an electrophoretic display panel, or any other display panel. When the display panel 100 is the LCD panel, as shown in FIG. 3, the display panel 100 includes an active device array substrate 101, an opposite substrate 104, a display medium 108, and at least one polarizer 110, 112. The active device array substrate 101 includes a substrate 102 and a pixel array layer 106 located on the substrate 102. The pixel array layer 106 normally includes scan lines, data lines, and sub-pixel structures that are electrically connected to the scan lines and the data lines. The opposite substrate 104 can be a blank substrate, a substrate having an electrode layer, or a substrate having an electrode layer and a color filter array. The display medium 108 includes liquid crystal molecules. The polarizers 110 and 112 respectively disposed on the active device array substrate 101 and the opposite substrate 104 allow light to have a certain polarization direction after the light passes through the display panel 100.

As indicated in FIG. 1A and FIG. 1B, the switching panel 200 is located above the display panel 100. The switching panel 200 and the display panel 100 can be fixed together by an adhesive or by a mechanical fixing member. Besides, the switching panel 200 includes a first substrate 202, a second substrate 204, a plurality of electrode patterns 206, and an optically anisotropic medium 208.

The first substrate 202 and the second substrate 204 are disposed opposite to each other and can be made of glass, quartz, organic polymer, or any other appropriate material. In this embodiment, the first substrate 202 is a blank substrate, i.e., no electrode layer is disposed on the surface of the first substrate 202.

The electrode patterns 206 are located on the second substrate 204. A material of the electrode patterns 206 includes a transparent conductive material, e.g., a metal oxide including indium tin oxide (ITO), indium zinc oxide (IZO), aluminum zinc oxide (AZO), aluminum tin oxide (ATO), indium gallium zinc oxide (IGZO), other suitable materials, or a stacked layer having at least two of the above-mentioned materials. In this embodiment, the vertical section of each pattern electrode 206 of the switching panel 200 is an arc-shaped section, which should not be construed as a limitation to the invention.

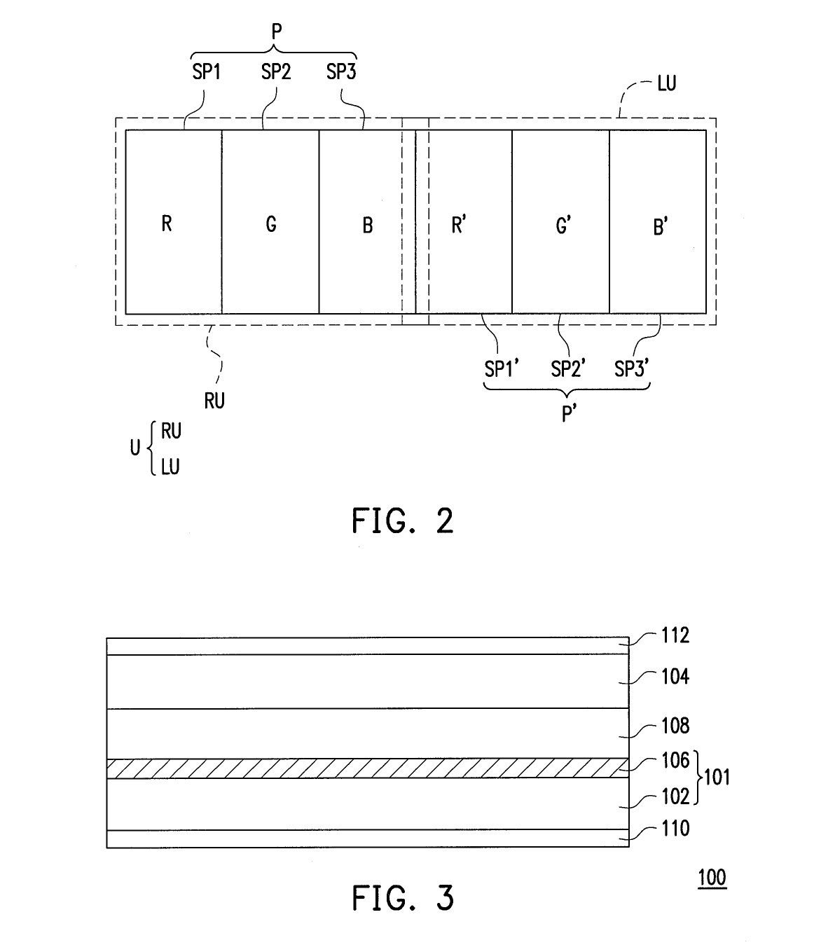

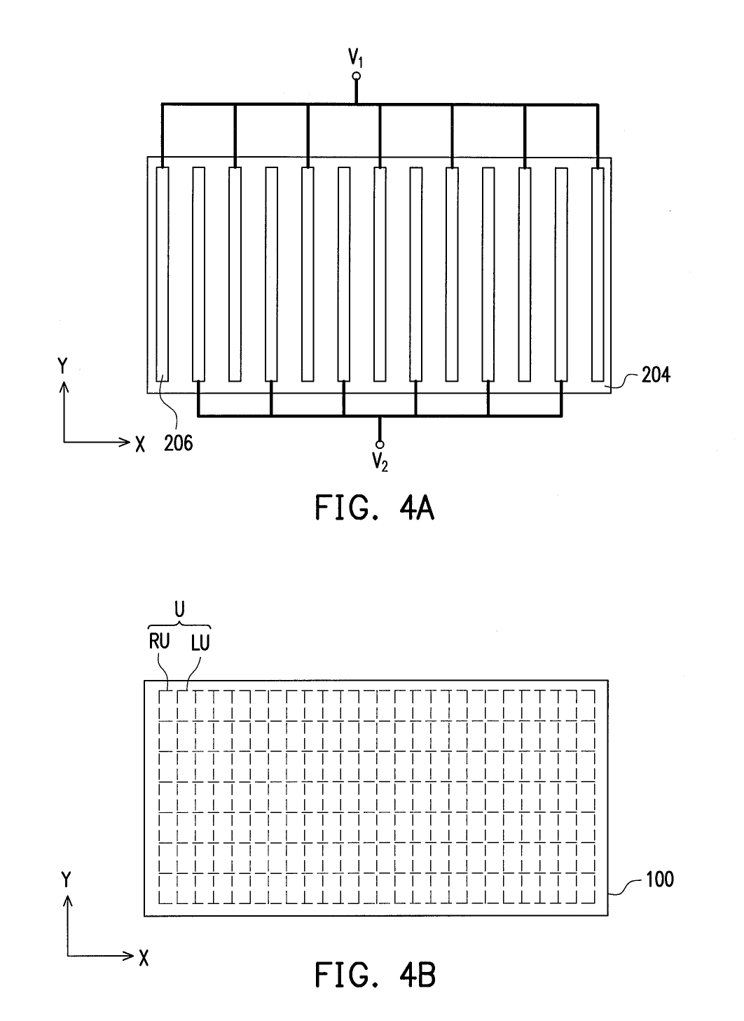

FIG. 4A is a top view illustrating the electrode patterns 206 in this embodiment. The electrode patterns 206 are bar-shaped electrode patterns, and each of the bar-shaped electrode patterns 206 extends from one edge to the other edge of the second substrate 204. The bar-shaped electrode patterns 206 are arranged in parallel to each other on the surface of the second substrate 204. When no voltage is applied to the individual electrode pattern 206, there is no electric field between two adjacent electrode patterns 206, as indicated in FIG. 1A. If it is intended to generate a lateral electric field E between two adjacent electrode patterns 206, as indicated in FIG. 1B, the odd electrode patterns 206 can be electrically connected to the first voltage V1, and the even electrode patterns 206 can be electrically connected to the second voltage V2, as indicated in FIG. 4A. Here, a voltage difference exists between the first and second voltages V1 and V2, i.e., the first voltage V1 is not equal to the second voltage V2.

According to this embodiment, the electrode patterns 206 on the second substrate 204 of the switching panel 200 are disposed corresponding to the unit regions U of the display panel 100. For instance, as shown in FIG. 4A and FIG. 4B, one of the unit regions U in the display panel 100 is correspondingly disposed between two adjacent electrode patterns 206. To be more specific, when the unit regions U are arranged in arrays along an x direction and a y direction, each line of the unit regions U is correspondingly disposed between two adjacent electrode patterns 206. Since the lateral electric field E (shown in FIG. 1) may be generated between two adjacent electrode patterns 206, the lateral electric field E between each set of electrode patterns 206 covers the left-eye and right-eye unit regions LU and RU.

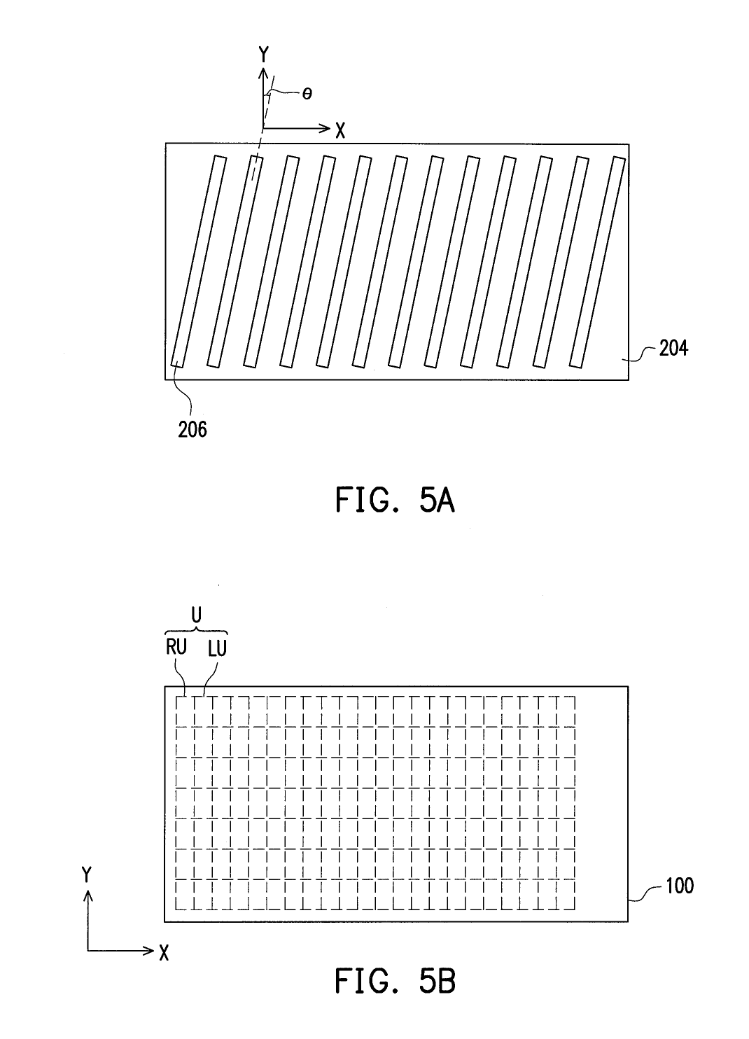

It should be mentioned that the extension direction of the electrode patterns 206 on the second substrate 204 of the switching panel 200 can be parallel to the y direction. In other words, the extension direction of the electrode patterns 206 on the second substrate 204 of the switching panel 200 is parallel to the unit regions U arranged in the y direction. However, the invention is not limited thereto. In other embodiments of the invention, as indicated in FIG. 5A and FIG. 5B, an included angle θ between the extension direction of the electrode patterns 206 on the second substrate 204 of the switching panel 200 and the y direction is not equal to 180 degrees. Namely, the extension direction of the electrode patterns 206 on the second substrate 204 of the switching panel 200 is not parallel to the unit regions U arranged in the y direction.

With reference to FIG. 1A and FIG. 1B, the optically anisotropic medium 208 of the switching panel 200 is located between the first substrate 202 and the second substrate 204. The optically anisotropic medium 208, for instance, is characterized by birefringence, e.g., liquid crystal molecules or other appropriate substance. The liquid crystal molecules taken as an example here often have a first axial refractive index (no) and a second axial refractive index (ne). The first axial refractive index (no) may be referred to as a short axial refractive index of the liquid crystal molecules, and the second axial refractive index (ne) may be referred to as a long axial refractive index of the liquid crystal molecules. The optically anisotropic medium 208 is arranged based on the electric field distribution in the switching panel 200. That is to say, when no electric field is generated in the switching panel 200, the optically anisotropic medium 208 is vertically or horizontally arranged in the switching panel 200. In FIG. 1A, the optically anisotropic medium 208 is vertically arranged, which should not be construed as a limitation to the invention. When the lateral electric field E is generated between two adjacent electrode patterns 206 in the switching panel 204, the optically anisotropic medium 208 is arranged based on the distribution of the lateral electric field E, as indicated in FIG. 1B. In FIG. 1B, the optically anisotropic medium 208 located right below the electrode patterns 206 (i.e., the optically anisotropic medium 208 located in the region A1) is substantially arranged in a vertical manner. The optically anisotropic medium 208 located right below a region between two adjacent electrode patterns 206 (i.e., the optically anisotropic medium 208 located in the region A2) is substantially arranged in a horizontal manner. The optically anisotropic medium 208 located in the region A3 between the regions A1 and A2 is arranged in an inclined manner based on the distribution of the electric field E. Note that the optically anisotropic medium 208 depicted in FIG. 1B is schematic. The actual arrangement and distribution of the optically anisotropic medium 208 right below the region between two adjacent electrode patterns 206 is shown in the simulation diagram of FIG. 1C. In FIG. 1C, the optically anisotropic medium 208 is arranged based on the distribution of the lateral electric field E.

The operation of the stereo display device of this embodiment in a two-dimensional display mode or a three-dimensional display mode is described below.

### Two-Dimensional Display

As indicated in FIG. 1A, when there is no lateral electric field between the electrode patterns 206 in the switching panel 200 (i.e., no voltage is applied to the individual electrode pattern 206 or a common voltage is applied to all of the electrode patterns 206), the optically anisotropic medium 208 is vertically or horizontally arranged between the first and second substrates 202 and 204. In FIG. 1A, the optically anisotropic medium 208 is vertically arranged, for instance, which should not be construed as a limitation to the invention. Hence, when the light L1 (with certain polarizing properties) coming from the display panel 100 passes through the optically anisotropic medium 208 of the switching panel 200, the optically anisotropic medium 208 is not characterized by birefringence. Hence, the birefringence effect does not occur when the light L1 passes through the optically anisotropic medium 208. In fact, the light L1 passes through the optically anisotropic medium 208 in parallel, so as to generate the light L1′. Since the light L1′ passes through the optically anisotropic medium 208 in parallel, and the light L1′ is neither converged nor scattered, the user above the switching panel 200 can observe two-dimensional images.

### Three-Dimensional Display

As indicated in FIG. 1B, when the lateral electric field E is generated between the electrode patterns 206 in the switching panel 200 (i.e., the first voltage V1 is applied to the odd electrode patterns 206, and the second voltage V2 is applied to the even electrode patterns 206), the optically anisotropic medium 208 is arranged between the first and second substrates 202 and 204 based on the distribution of the electric field E. Therefore, when the light L1 (with certain polarizing properties) coming from the display panel 100 passes through the optically anisotropic medium 208 of the switching panel 200, the optically anisotropic medium 208 located in the regions A3 and A2 has different refraction indexes due to different arrangement directions, such that the light L1 is refracted to form the light L2 and the light L3 when the light L1 passes through the optically anisotropic medium 208 located in the regions A3. Owing to the different directions of refraction of the light L2 and the light L3, the light L2 can be transmitted to the right eye of the user, and the light L3 can be transmitted to the left eye of the user. Thereby, the user can observe the three-dimensional images (stereo images).

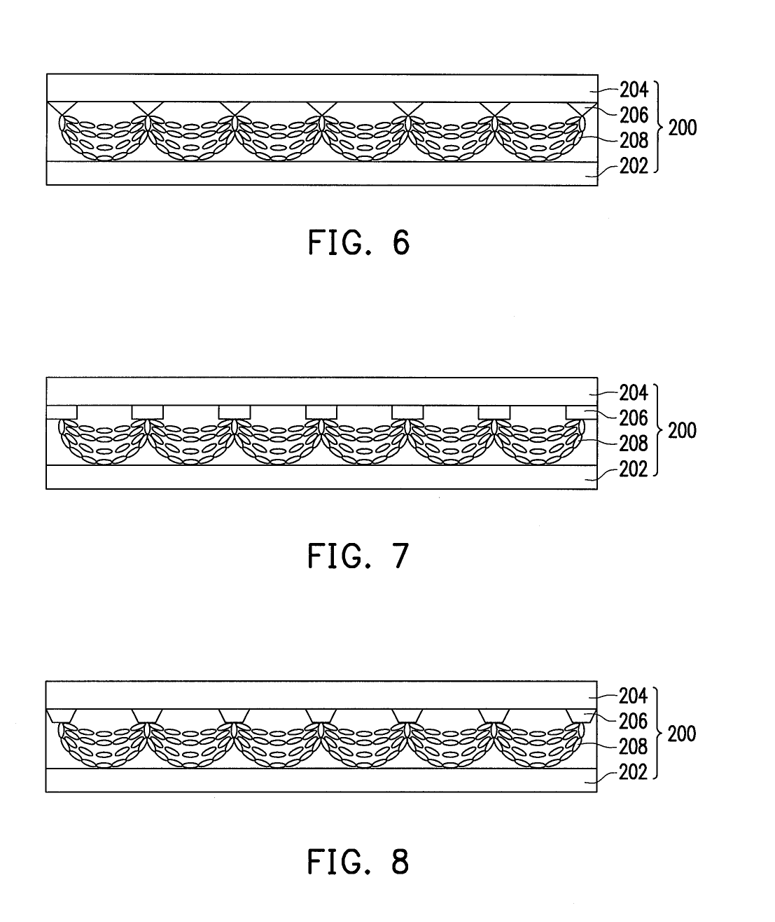

In the embodiment shown in FIG. 1A and FIG. 1B, the vertical section of each of the electrode patterns 206 in the switching panel 200 is an arc-shaped section. However, according to other embodiments of the invention, the vertical section of each of the electrode patterns 206 of the switching panel 200 can be in other shapes. For instance, the vertical section of each of the electrode patterns 206 of the switching panel 200 can be a triangular section, as indicated in FIG. 6. The vertical section of each of the electrode patterns 206 of the switching panel 200 can also be a rectangular section, as indicated in FIG. 7. Moreover, the vertical section of each of the electrode patterns 206 of the switching panel 200 can be a trapezoid section, as indicated in FIG. 8.

Note that the electrode patterns 206 of the switching panel 200 are disposed on the second substrate 204 in the embodiments shown in FIG. 1A, FIG. 1B, and FIG. 6 to FIG. 8. However, the invention is not limited thereto. The electrode patterns 206 of the switching panel 200 in other embodiments can also be disposed on the first substrate 202, and no electrode layer is disposed on the second substrate 204.

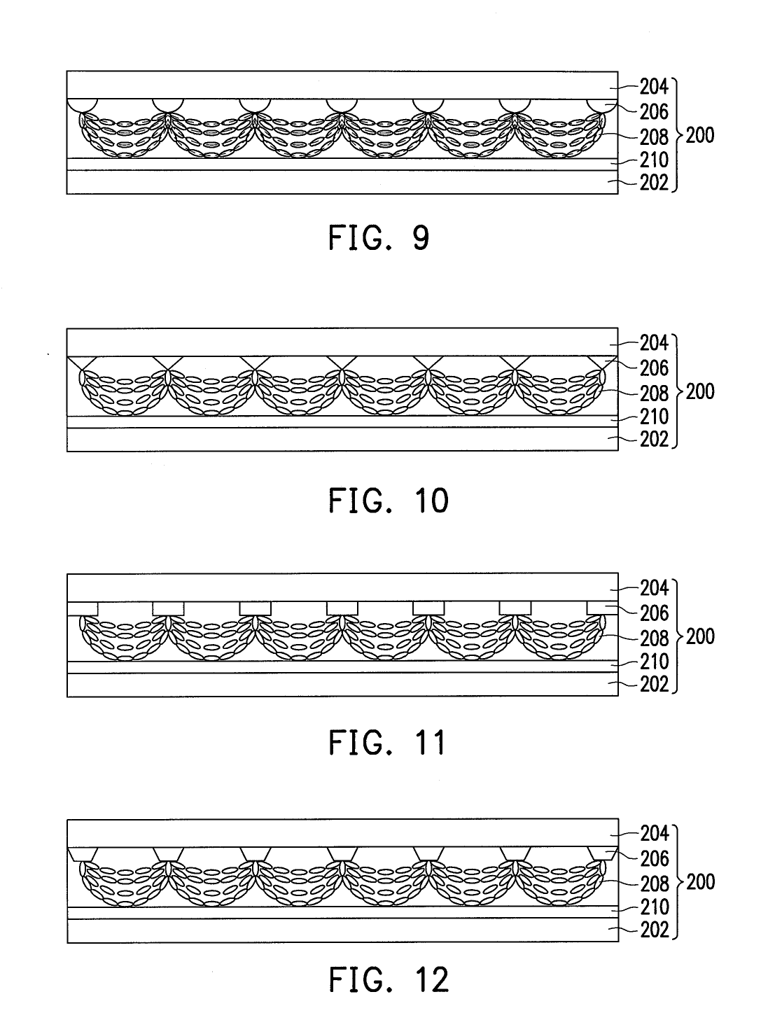

FIG. 9 is a schematic cross-sectional view illustrating a switching panel in a stereo display device according to an embodiment of the invention. With reference to FIG. 9, the switching panel of this embodiment is similar to the switching panel of the stereo display device depicted in FIG. 1A and FIG. 1B, and therefore the same elements in FIG. 9 and in FIG. 1A, FIG. 1B are represented by the same reference numbers and will not be further elaborated. In the embodiment shown in FIG. 9, the switching panel 200 further includes a floating electrode layer 210 that is disposed on the surface of the first substrate 202. The floating electrode layer 210 is in an electrically floating state, i.e., no voltage is applied to the floating electrode layer 210. A material of the floating electrode layer 210 includes a transparent conductive material, e.g., a metal oxide including ITO, IZO, AZO, ATO, IGZO, other suitable materials, or a stacked layer having at least two of the above-mentioned materials. Since the floating electrode layer 210 is in a floating state, the configuration of the floating electrode layer 210 does not pose an impact on the lateral electric field that is generated between the adjacent electrode patterns 206. The floating electrode layer 210 disposed on the surface of the first substrate 202 of the switching panel 200 can serve as a cover layer that can isolate the switching panel 200 from the external electric field, so as to prevent the external electric field from affecting the optically anisotropic medium 208 in the switching panel 200.

Similarly, in the embodiment shown in FIG. 9, the floating electrode layer 210 is disposed on the first substrate 202 of the switching panel 200, the electrode patterns 206 are disposed on the second substrate 204 of the switching panel 200, and the vertical section of each of the electrode patterns 206 is an arc-shaped section. However, the invention is not limited thereto. In other embodiments of the invention, the vertical section of each of the electrode patterns 206 of the switching panel 200 can be in other shapes.

For instance, as shown in FIG. 10, the floating electrode layer 210 is disposed on the first substrate 202 of the switching panel 200, the electrode patterns 206 are disposed on the second substrate 204 of the switching panel 200, and the vertical section of each of the electrode patterns 206 is a triangular section.

In addition, as shown in FIG. 11, the floating electrode layer 210 is disposed on the first substrate 202 of the switching panel 200, the electrode patterns 206 are disposed on the second substrate 204 of the switching panel 200, and the vertical section of each of the electrode patterns 206 is a rectangular section.

In the embodiment shown in FIG. 12, the floating electrode layer 210 is disposed on the first substrate 202 of the switching panel 200, the electrode patterns 206 are disposed on the second substrate 204 of the switching panel 200, and the vertical section of each of the electrode patterns 206 is a trapezoid section.

In the embodiments shown in FIG. 9 to FIG. 12, the electrode patterns 206 of the switching panel 200 are disposed on the second substrate 204 (i.e., one of the two substrates of the switching panel 200 relatively away from the display panel 100), and the floating electrode layer 210 of the switching panel 200 is disposed on the first substrate 202 (i.e., one of the two substrates of the switching panel 200 relatively close to the display panel 100). However, the invention is not limited thereto. According to other embodiments of the invention, the electrode patterns 206 of the switching panel 200 can also be disposed on the first substrate 202 (i.e., one of the two substrates of the switching panel 200 relatively close to the display panel 100), and the floating electrode layer 210 of the switching panel 200 can be disposed on the second substrate 204 (i.e., one of the two substrates of the switching panel 200 relatively away from the display panel 100).

In light of the foregoing, the stereo display device described in the embodiments of the invention can achieve the stereo display effect merely by disposing the switching panel above the display panel, and the switching panel allows the stereo display device to switch between the two-dimensional display mode and the three-dimensional display mode. Namely, the cylindrical lenses need not be disposed on the display panel of the stereo display device according to the embodiments of the invention, and the entire thickness of the stereo display device described in the embodiments of the invention is less than the thickness of the conventional stereo display device. Moreover, fabrication of the stereo display device of this invention is less complicated and more cost-effective.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A stereo display device comprising:
a display panel having a plurality of unit regions, each of the unit regions comprising a right-eye unit region and a left-eye unit region; and
a switching panel located above the display panel and comprising:
a first substrate;
a second substrate located opposite to the first substrate;
a plurality of electrode patterns located on the second substrate; and
an optically anisotropic medium located between the first substrate and the second substrate.

2. The stereo display device as recited in claim 1, wherein the electrode patterns are bar-shaped electrode patterns, and each of the bar-shaped electrode patterns extends from one edge to the other edge of the second substrate.

3. The stereo display device as recited in claim 1, wherein the electrode patterns comprise a plurality of odd electrode patterns and a plurality of even electrode patterns, the odd electrode patterns are electrically connected to a first voltage, and the even electrode patterns are electrically connected to a second voltage, such that a lateral electric field is generated between each of the odd electrode patterns and an adjacent even electrode pattern of the even electrode patterns.

4. The stereo display device as recited in claim 1, wherein a vertical section of each of the electrode patterns is an arc-shaped section, a trapezoid section, a rectangular section, or a triangular section.

5. The stereo display device as recited in claim 1, wherein no electrode layer is disposed on a surface of the first substrate.

6. The stereo display device as recited in claim 1, further comprising a floating electrode layer located on a surface of the first substrate.

7. The stereo display device as recited in claim 1, wherein two adjacent electrode patterns of the electrode patterns are disposed corresponding to one of the unit regions of the display panel.

8. The stereo display device as recited in claim 7, wherein each of the right-eye unit region and the left-eye unit region of the one of the unit regions includes at least one pixel structure.

9. The stereo display device as recited in claim 8, wherein each of the pixel structures includes a red sub-pixel structure, a green sub-pixel structure, and a blue sub-pixel structure.

10. The stereo display device as recited in claim 1, wherein the display panel comprises:
an active device array substrate;
an opposite substrate located opposite to the active device array substrate;
a display medium located between the active device array substrate and the opposite substrate; and
at least one polarizer located on a surface of the opposite substrate.

11. The stereo display device as recited in claim 1, wherein the unit regions are arranged in an array in an x direction and a y direction, and an extension direction of the electrode patterns is parallel to the y direction.

12. The stereo display device as recited in claim 1, wherein the unit regions are arranged in an array in an x direction and a y direction, and an included angle between an extension direction of the electrode patterns and the y direction is not equal to 180 degrees.

13. A switching panel of a stereo display device, suitable for being combined with a display panel to form the stereo display device, the display panel having a plurality of unit regions, each of the unit regions comprising a left-eye unit region and a right-eye unit region, the switching panel of the stereo display device comprising:
a first substrate;
a second substrate located opposite to the first substrate;
a plurality of electrode patterns located on the second substrate, two adjacent electrode patterns of the electrode patterns being disposed corresponding to one of the unit regions of the display panel; and
an optically anisotropic medium located between the first substrate and the second substrate.

14. The switching panel of the stereo display device as recited in claim 13, wherein the electrode patterns are bar-shaped electrode patterns, and each of the bar-shaped electrode patterns extends from one edge to the other edge of the second substrate.

15. The switching panel of the stereo display device as recited in claim 13, wherein the electrode patterns comprise a plurality of odd electrode patterns and a plurality of even electrode patterns, the odd electrode patterns are electrically connected to a first voltage, and the even electrode patterns are electrically connected to a second voltage, such that a lateral electric field is generated between each of the odd electrode patterns and an adjacent even electrode pattern of the even electrode patterns.

16. The switching panel of the stereo display device as recited in claim 13, wherein a vertical section of each of the electrode patterns is an arc-shaped section, a trapezoid section, a rectangular section, or a triangular section.

17. The switching panel of the stereo display device as recited in claim 13, wherein no electrode layer is disposed on a surface of the first substrate.

18. The switching panel of the stereo display device as recited in claim 13, further comprising a floating electrode layer located on a surface of the first substrate.

19. The switching panel of the stereo display device as recited in claim 13, wherein the unit regions are arranged in an array in an x direction and a y direction, and an extension direction of the electrode patterns is parallel to the y direction.

20. The switching panel of the stereo display device as recited in claim 13, wherein the unit regions are arranged in an array in an x direction and a y direction, and an included angle between an extension direction of the electrode patterns and the y direction is not equal to 180 degrees.
